(19) United States
(12) Patent Application Publication
(10) Pub. No.: US 2018/0204445 A1
(43) Pub. Date: Jul. 19, 2018

(54) Method of signaling distress in an event of threat to personal safety and device for implementing same

(71) Applicants: Leonid Mikhailovich BERESHCHANSKIY, Moscow (RU); Nikita Olegovich LOBACHEV, Moscow (RU)

(72) Inventors: Leonid Mikhailovich BERESHCHANSKIY, Moscow (RU); Nikita Olegovich LOBACHEV, Moscow (RU)

(21) Appl. No.: 15/743,624

(22) PCT Filed: Apr. 7, 2016
(86) PCT No.: PCT/RU2016/000202

§ 371 Date: Jan. 10, 2018

(30) Foreign Application Priority Data
Jul. 24, 2015 (RU) 2015130752
Jul. 24, 2015 (RU) 2015130753

(51) Int. Cl. G08B 25/01; A44C 9/00; G08B 25/00

(52) U.S. Cl. CPC G08B 25/016; H04W 4/80; G08B 25/001; A44C 9/00

(57) ABSTRACT

A personal threat warning device includes a body in a form of a ring; an internal power supply inside the body; a processor connected to the power supply; a wireless transmission unit for transmitting a signal representing a user personal threat warning to an external receiver; a physical button installed outside the body for initiating the signal; wherein the physical button is installed on an external face of the body, in a segment of a second and third quadrants in a clockwise direction on the body. The power supply is located at a top of the body. The processor, the wireless transmission unit and an antenna are located above the power supply. A vibrating motor that vibrates when the physical button is held down. The processor initiates signal transmission using the wireless transmission unit after deactivating the vibration motor.

### BACKGROUND OF THE INVENTION

### Field of the Invention

The present invention relates to the field of personal informing of certain organizations (such as government agencies) of an emergency, sending of alarm signal to these organizations, appeal for help and providing a location of person in need of help.

### Description of the Related Art

Technical solutions in the field of design of alarm devices located on the human body including those in the form of a ring or a finger-ring, which include a function of secret sending of signals for assistance and location to emergency response services or to other persons, are known in the prior art. The prior art also describes features of embodiment of this device in a simplified diagram using processor, means of signal transmission over a distance, and an alarm button.

Thus, warning methods and devices are known that use a so called “alarm button” that is a small radio transmitter with a control button on the body. The radio transmitter is activated by pressing the control button in case of danger to human life, health and material possessions, in particular in case of threat to an employee of a relevant uniformed service. The radio signal (radio alarm signal) sent with the “alarm button” is received in a centralized guard station and is generated as an alarm message after processing and decoding indicating identification signs of the “alarm button” that sent the radio alarm signal. Sound and/or light alarm is used in case of indication of alarm message in the specified centralized guard stations. In particular, different options of devices for technical implementation of this method are presented in US Patent Publication No. 2001/0052848, and U.S. Pat. No. 6,310,539.

The disadvantages of this technical solution include small coverage of the “alarm button” and a lack of information on location of radio signal source in the radio alarm signal. Moreover, in case of sudden attack, the user might fail to use this warning device.

In addition, there are known personal threat warning devices made in the form of a ring or a finger-ring, i.e., in the form of comfortably and permanently worn item that does not raise attacker's previously formed negative attitudes or suspicions (see US Publication No. 200800182547, published on 31 Jul. 2008).

This patent describes personal threat warning device comprising a body made as a circular element worn on a user's finger, an internal cavity that accommodates a power supply, a processor unit, a microphone and a unit for signal transmission through wireless communication to an externally located receiver of this signal—a mobile phone which is connected in the forwarding mode with a subject assuring user security, as well as a button which is installed outside the body for initiation of generation of the signal representing a user personal threat warning signal, in case of voice message sending through microphone to processor unit.

One feature of such rings or finger-rings is that the alarm button is always located on the external face of product to be pressed by either finger of another hand or by resting upon any object. The known analogous solutions and prior art have one major disadvantage that is an impossibility to send alarm signal and location instantly, for example, in case of hand motions limitation.

Moreover, the arrangement architecture of such a device provides that all the elements are mounted on one common board incorporated into the body. In this case one ring is replaced completely with a new one or a motherboard is dismantled and new one is installed in case of failure. Generally, such architecture is used for single-use products or for products whose service life is determined with a time period prior to the first failure. It makes economic sense for the manufacturer, since it results in increase of merchandise turnover and replaceability, but it is not advantageous for consumer.

Product reliability and durability are important for a user, and these parameters are determined not only with reliability of installed components but with their effect on each other during the operation. It is particularly important when assemblies, for example, a processor and a vibrating motor that are different in design and functions are used. In this regard a distributed architecture is preferable since it allows distributing of these assemblies with features different in design and functions to a certain distance, in this case their effect on each other is excluded or, at least, reduced.

In case of emergencies, a person might not be able to inform of need for help and his/her location. Most people feel concern about their friends and family when they are not with them. Nowadays people rely on a mobile phone and active self-defense means. All the current methods of informing that a person needs help have one common and major disadvantage—that is, unavailability to send alarm signal and location instantly, for example, in case of hand motions limitation. (In an emergency it is not possible to find a phone and any pendants in the bag, pocket or things and use quickly and promptly and a second hand is required to perform an action for use of alarm button on the watch or bracelet that may be impossible in some cases).

A method of personal threat warning is known from the same source (US 200800182547), which includes a mobile device registration of identification data of ring or finger-ring worn on the user's finger and equipped with processor unit, microphone and unit of signal transmission through wireless communication by pressing a physical button on this ring or finger-ring, and in case signs of personal threat can be identified, the physical button is pressed to initiate the processor unit, microphone and signal transmission unit, then a voice message is sent through microphone on the ring or finger-ring and transmitted in wireless communication mode to a mobile device, wherefrom the personal threat signal is transmitted in the forwarding mode to an organization provided with the functions of assurance of user security.

The disadvantage of this method is that both user's hands are required for transmission of an alarm signal. Moreover, it is impossible to cancel a call in case of a false triggering. Voice message use is also a troublesome matter, since it is not always possible due to circumstances of the situation, and for microphone operation it is necessary to bring the ring close to the mouth, which may be impossible in some cases, and in case of offset distance from the mouth, it is necessary to raise voice, which is also not always practicable.

Moreover, the user is not informed of a sent alarm signal or operating device. In case of difficult situation of possible threat, lack of a feedback may also be a problem.

### SUMMARY OF THE INVENTION

The present invention provides a possibility to send an alarm signal and location with one finger motion, even in case of hand motions limitation, and without voice messages, and also provides for a possibility of false call cancellation.

The technical result for the device includes a body made in the form of a ring or finger-ring worn on a user's finger with an internal power supply, a processor and a signal transmission unit through wireless communications to an externally located receiver, as well as a physical button installed outside the body for initiation of generation of the signal representing a user personal threat warning signal. The physical button is installed outside the body on the external face thereof, in the segment of the second and third quadrant in the clockwise direction, the power supply is located at the top of the body, above which the processor, the signal transmission unit and the antenna are located, one side of which accommodates a vibrating motor for sending vibration signals when holding the physical button down, and the other side accommodates the physical button.

Moreover, this device can be additionally equipped with a positioning unit connected to a processor unit for transmission of a user personal threat warning and location data in the signal packet. Also, it can be additionally equipped with a unit of signal reception from a computerized means (mobile device) to cancel sending of a signal, which is user's personal threat warning signal. A unit working according to the BLUETOOTH protocols is used as the signal transmission unit.

Moreover, the device can be additionally equipped with at least one LED installed on the internal surface of the ring or finger-ring shank for visual indication of an operation mode of the device. Also, the device can be additionally equipped with a communication unit to a geolocation system to form a location signal and transmit it to a signal transmission unit with antenna.

The disadvantage of prior art is eliminated owing to a form factor of ring (finger-ring) and convenient location of alarm button that allows alarm signal and location sending with one finger motion, even if a person's hand motions are limited.

The technical result for the method includes an application of the mobile device of the processor programs to a ring or a finger-ring worn on a user's finger, which is equipped with the unit of signal transmission through wireless communication when pressing the physical button on this ring or finger-ring, and in case a personal threat can be identified, the physical button is pressed to initiate the processor, as well as signal transmission unit and form a signal that is the personal threat warning signal, and transmit this signal through wireless communication to a mobile device available remotely, wherefrom the personal threat signal is transmitted in a forwarding mode to an organization provided with the functions of assurance of user security, to initiate the processor and signal transmission unit to form a personal threat warning signal, the physical button on the ring or finger-ring is pressed and held down for N seconds, after which the processor unit forms and transmits a signal to the signal transmission unit to send it to the organization. In case of false pressing on the physical button during the time exceeding N seconds, the user cancels the call by entering the password in the application installed in his/her mobile device.

It enhances reliability of the protection method and increases chances of a person for rescue in an emergency.

These aspects are related to formation of the steady combination of the features sufficient for achievement of the necessary technical result.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a section of the finger-ring to present an arrangement of elements;

FIG. 2 shows another view of the finger-ring arrangement of FIG. 1;

FIG. 3 shows a second embodiment of the finger-ring;

FIG. 4 shows another view of the finger-ring of FIG. 3;

FIG. 5 shows a third embodiment of the finger-ring;

FIG. 6 shows another view of the finger-ring of FIG. 5;

FIG. 7 shows a block diagram of a device electric circuit that may be used in the present invention.

### DETAILED DESCRIPTION OF THE PREFERRED EMBODIMENTS

Reference will now be made in detail to the preferred embodiments of the present invention, examples of which are illustrated in the accompanying drawings.

The present invention provides a personal threat warning device worn on a hand of a user. This device informs certain organizations of an emergency, in which a person needs help.

In general the personal threat warning device comprises a body made in the form of a ring or a finger-ring worn on a user's finger, an internal cavity of whereof accommodates a power supply, a programmable processor and a unit of signal transmission through wireless communication to an externally located receiver of this signal, and a physical button installed outside the body for initiating generation of the signal representing a user personal threat warning signal.

The physical button for initiating generation of the signal representing a user personal threat warning signal is installed outside on an internal surface of a shank of the ring or finger-ring on a segment of the second and third quadrants in the clockwise direction.

The power source is located at the top of the body, one side of which accommodates a vibrating motor with its control circuit board for sending vibration signals when pressing the physical button for initiating signal generation and while holding it down, as well as a power supply to charge the control circuit board, and the other side of which accommodates a circuit board with a processor unit and a signal transmission unit with an antenna. The processor unit is made with a function of initiation of signal transmission to a signal transmission unit upon deactivating the vibration motor.

Moreover, this device can be additionally equipped with a positioning unit connected to the processor unit for transmission of a signal packet representing the user personal threat warning signal and location data. Or it can be additionally equipped with a unit of signal reception from a mobile device for entering cancelling sending of a signal, which is the user personal threat warning signal. A unit operating on the basis of the BLUETOOTH protocol is used as the signal transmission unit. A mobile device (also known as a handheld device, handheld computer or simply handheld), as used herein, is a small, hand-held computing device, typically having a display screen with touch input and/or a miniature keyboard. APPLE, SAMSUNG, HTC, LG, and MOTOROLA are some of the examples of the manufacturers that produce these types of devices. A handheld computing device has an operating system (OS), and can run various types of application software, known as apps. Most hand held devices can also be equipped with WI-FI, BLUETOOTH and GPS capabilities that can allow connections to the Internet and other BLUETOOTH capable devices such as an automobile or a microphone headset. A camera or media player feature for video or music files can also be typically found on these devices along with a stable battery power source, such as a lithium battery.

Moreover, the device can be additionally equipped with at least one LED installed on the internal surface of the ring or finger-ring shank for visual indication of an operation mode of the device. Also the device can be additionally equipped with a unit of communication with the geolocation system to form and transmit a location signal to the signal transmission unit with the antenna.

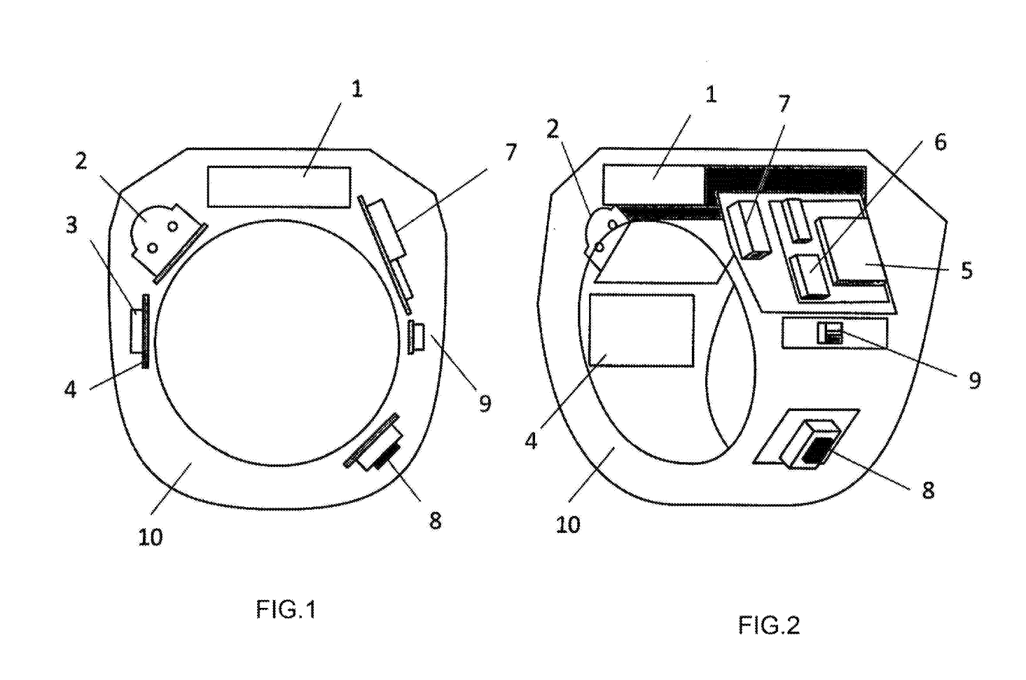

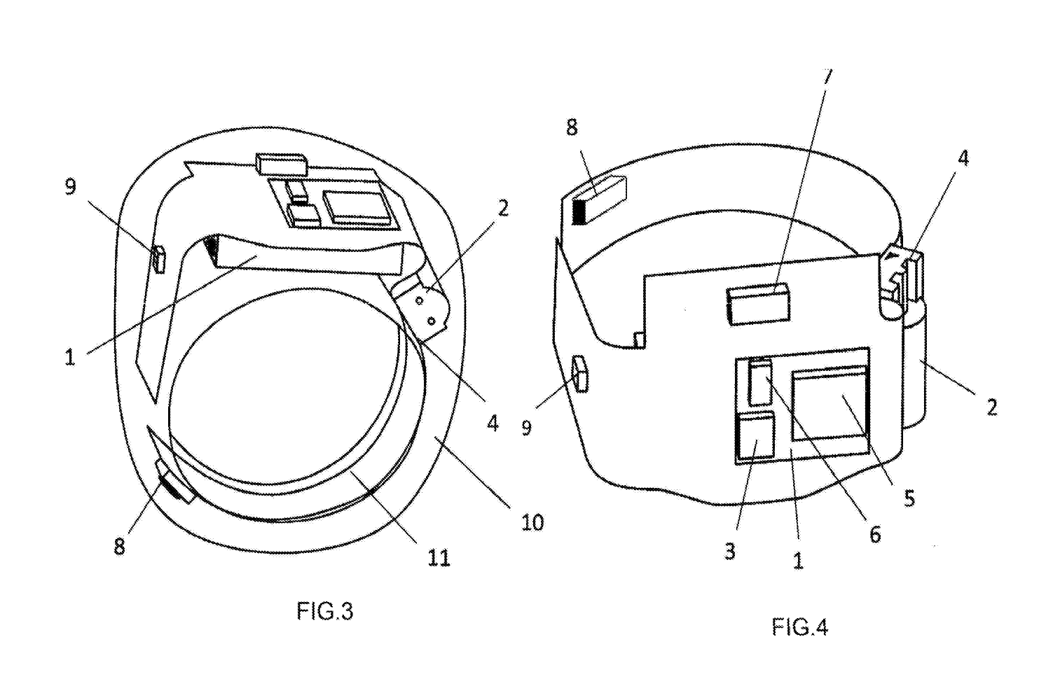

The wearable electronic device is a ring (finger-ring) with an alarm physical button (FIGS. 1 and 2).

The inner layout scheme of the device is located at its top. The button, pressing whereupon alarm signal sending is initiated, is located at the bottom portion of the device on an outer radius of the finger-ring and on the side face if the finger-ring is viewed as a clock dial, so that the button may be located within the range from 3 to 9 o'clock in clockwise direction.

The wearable electronic device may be linked with a smartphone through a wireless connection and using an application on the smartphone. The wearable electronic device may be completely standalone by comprising components for positioning (GPS, GLONASS, etc.) and for communication signals transmission (GSM, CDMA, etc.).

The body of this device can be made of any known material.

The device includes, but is not limited by the following layout scheme: power supply (battery) 1, vibrating motor 2, power supply charge control circuit board 3, vibrating motor control board 4, processor unit 5, BLUETOOTH signal transmission unit 6, antenna 7 for BLUETOOTH unit 6, physical button 8, LEDs 9 (for visualization of ongoing processes that are outputted to the internal side of the ring or finger-ring shank), body of the product 10.

All operations are powered by the battery. When physical button 8 is held down, for example, for three seconds, vibrating motor 2, in case it communicates with vibrating motor control board 4 and processor unit 5, keeps vibrating during the entire period of holding down of button 8. At the end of, for example, three seconds, BLUETOOTH unit 5 detects this set period has expired and sends a signal through unit 6 to a linked mobile device using antenna 7 for further set scripting.

At the same time, LED 9 may indicate system health. At least one LED installed on the internal surface of a circular element near physical button 8 is used in this device.

The alarm button is located on the internal (in the bottom portion of the ring) surface of the product on the shank, at its internal side, which allows to send the alarm signal and his/her location by a movement of a finger even if a person's hand motions are limited. For this purpose it is enough for the user to press the ring down with another finger until pushing the button in or to press the fingers together.

Another feature of this design is that as to the physical alarm button located on the ring worn on a finger, to send an alarm signal a user needs to hold down the button for N seconds (in this case the wearable electronic device will vibrate indicating that a user is going to send an alarm signal). As to the electronic alarm button, a user shall also hold it down for N seconds. In case of false pressing, a user has N seconds to cancel the alarm signal through an application by entering his/her personal secret password.

A program algorithm can be used to cancel false pressing.

Moreover, arrangement architecture of the known finger-rings and rings provides an electronic part made in the form of a monoblock unit, which can be inserted into a mortise (socket) of the finger-ring. A spaced arrangement is used in the utility model, what means that each element of the electronic part is located in a prescribed mortise on a flexible board and can be separated from the other, dismounted and replaced.

This device can be developed in another arrangement embodiment presented on FIGS. 3 and 4.

In general and optionally (FIGS. 3 and 4) the personal threat warning device comprises body 10 made in the form of the ring or finger-ring worn on a user's finger, an internal cavity that accommodates power supply 1, processor unit 5 and unit 6 of BLUETOOTH signal transmission through wireless communication to an externally located receiver of this signal, and a physical button 8 installed outside the body for initiating generation of the signal representing the user personal threat warning signal.

Button 8 for initiating generation of the signal representing the user personal threat warning signal is installed on the external surface of the circular element on the second and third quadrants segment in the clockwise direction. The same side (the button side) accommodates the LED indicator (LEDs 9) for light indication of operation modes of the ring or finger-ring.

The electronic components are mounted on flexible board 11 built into the cavity of the circular element, the power supply 1 is located at the top of the body of the circular element and on the internal surface of the shank.

The reverse side of the shank in relation to the power supply accommodates a board with the processor unit and signal transmission unit, as well as antenna 7 (antenna 7 for BLUETOOTH unit 6) for the signal transmission unit, the LED indicator is located on one side of the board, and vibrating motor for sending vibration signals when pressing the button for initiation signal generation and while holding it down is located on the other side of the board. As for the rest, this variant is similar to the first example of embodiment.

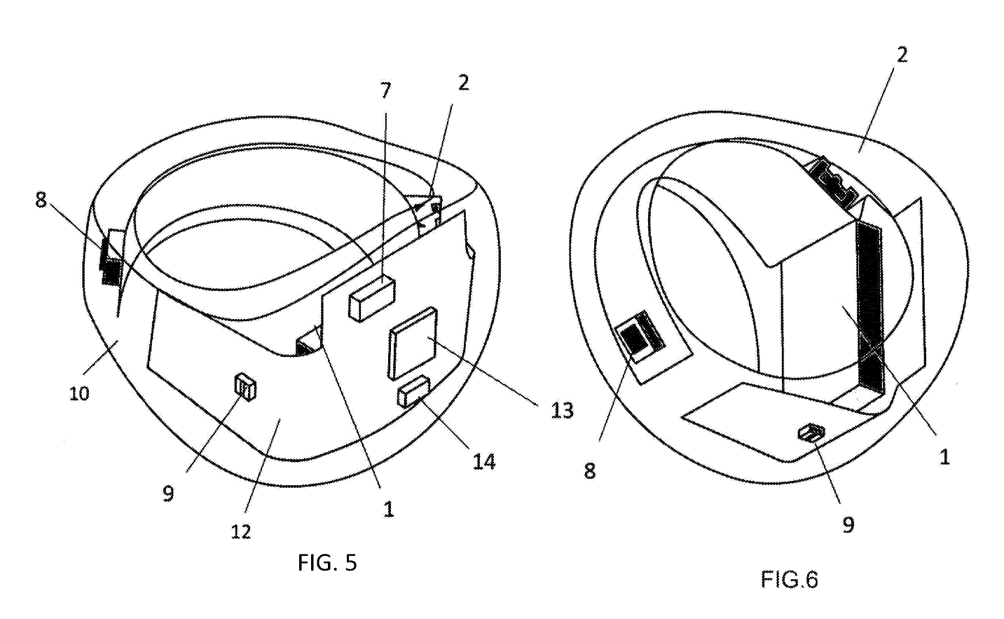

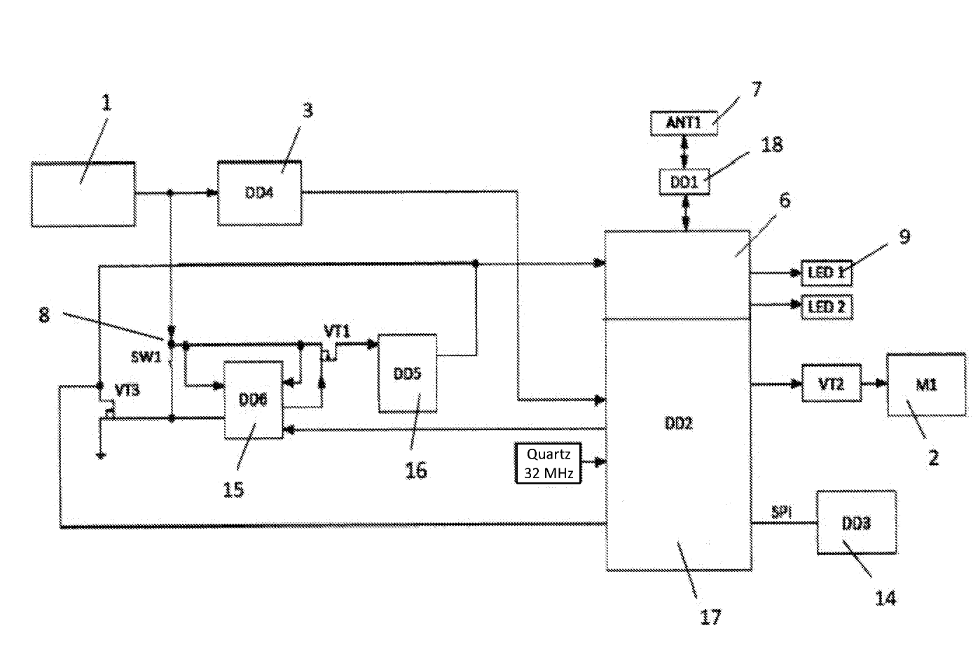

It is possible to make an embodiment of the invention, in which the processor and the unit of signal transmission through wireless communication shall be made in the form of a microprocessor board representing a single-chip BLUETOOTH controller with a built-in processor performing the functions of the processor and the unit of signal transmission through the antenna (FIGS. 5 and 6).

In this solution, as well as in those considered earlier, the button for initiating generation of the signal representing the user personal threat warning signal is installed on the external surface of the circular element on the second and third quadrants segment in the clockwise direction. The same side (the button side) accommodates the LED indicator(s) for light indication of operation modes of the ring or finger-ring.

Electronic components are mounted on a flexible stripe-shaped board built into the circular element cavity, the power supply is located at the top of the circular element body on the internal surface of this flexible board, the reverse side whereof in relation to the power supply accommodates a microprocessor board representing a single-chip BLUETOOTH controller with a built-in processor performing functions of a processor and a signal transmission unit, a memory unit for this controller and an antenna, at least one LED indicator is located on one side of the board, and a vibrating motor for sending vibration signals when pressing the button for initiating signal generation and while holding it down is located on the other side of the board, whereby the controller initiates signal transmission through the antenna upon deactivating the vibrating motor.

Like all the other examples, this device can be additionally equipped with positioning unit connected to the controller for transmission of the signal packet representing the user's personal threat warning signal and location data. Also, it can be additionally equipped with a unit of signal reception from a mobile device for entering a signal on cancellation of sending of a signal, which is the user personal threat warning signal.

The wearable electronic device is a ring (finger-ring) with an alarm button (FIGS. 5 and 6).

An inner layout circuitry of the device is mounted on a flexible stripe-shaped board going through the body of a ring or a finger-ring (the flexible board is used for holding electronic components, and also is a system of conductors for connection of all components in accordance with the wiring diagram). The button, where an alarm signal sending is initiated upon pressing, is located in the lower part of the device on the external (outer) face of the finger-ring body and on the side face if the finger-ring is viewed as a clock dial, so that the button may be located within the range from 3 to 9 o'clock in a clockwise direction.

The wearable electronic device may be linked with any smartphone through wireless connection.

The wearable electronic device may be completely standalone by comprising components (units) for positioning (GPS, GLONASS, etc.) and units for transmission of signals through communication protocols for communication signals transmission (GSM, CDMA, etc.).

The device in FIGS. 5 and 6 comprises, but is not limited by the following components: battery 1, vibrating motor 2 with the control board thereof, flexible stripe-shaped board 12, microprocessor BLUETOOTH module 13, antenna 7 for BLUETOOTH module, physical button 8, LEDs 9 (LED indicator for visualization of ongoing processes is outputted to the outer side of the ring or finger-ring), body 10, as well as memory unit 14 for BLUETOOTH module 13. Microprocessor BLUETOOTH module 13 means, for example, CC2540 BLUETOOTH chip which is a single-chip BLUETOOTH controller with a built-in processor serving as a processor and signal transmission unit. Alternatively, for example, AT76C551 which is a single-chip controller designed to arrange high-speed short distance data transmission through a radio channel within permitted ISM radio frequency band. AT76C551 comprises a radio frequency processor. This processor performs all processing of a digital stream including modulation and demodulation according to BLUETOOTH standard. The device controls the transceiver and pre-determined voice codec. AT76C551 comprises ARM7TDMI microprocessor core that supports operation with external and internal storage through the microprocessor interface.

All operations are powered by battery 1. When physical button 8 is held down for three seconds vibrating motor 2, in case it communicates with the vibrating motor control board and BLUETOOTH 13, keeps vibrating during the entire period of holding down of button 8.

Three seconds later BLUETOOTH module 13 detects that this set period has expired and sends a signal through the BLUETOOTH module to a linked mobile device using antenna 7 for further set writing.

At the same time, LED 9 may indicate system health.

The claimed invention is also featured by the alarm signal that may be sent directly to an organization selected by a user, or this alarm signal may be sent to certain organizations along with user's location using any communication system (GSM, CDMA, WI-FI, WI-MAX, BLUETOOTH, etc.) or through other computerized communication means (a mobile device) located nearby and serving as re-transmitters for the device.

Use of such a finger-ring or a ring makes it possible to implement the personal threat warning method. This method includes programming the processor of a ring or a finger-ring worn on the user's finger and equipped with the wireless communication signal transmission unit by using the application of a mobile device of the user by pressing the physical button. In case a personal threat can be identified the physical button is pressed to initiate the processor unit and signal transmission unit to form a signal that is the personal threat warning signal, and to transmit it through wireless communication to the mobile device available remotely, wherefrom the personal threat signal is transmitted in the forwarding mode to an organization provided with the functions of assurance of user security. To initiate the processor and signal transmission units to form a personal threat warning signal, the physical button on the ring or finger-ring is pressed and held down for N seconds after which the processor unit forms and transmits a signal to the signal transmission unit to send it to the organization who, upon receipt of the signal, makes a phone call to the user's mobile communication means to receive confirmation of personal threat existence.

In case of false pressing of the physical button during the time exceeding N seconds the user cancels call by entering the password in the application installed in his/her mobile device. A person in an emergency and in need of help may use smartphone software and/or a special worn electronic device (for example, a finger-ring) to send an alarm signal and his/her location to certain organizations or people.

In particular, these organizations or people may be represented, but not limited by:
relatives, friends, family members,
state security services,
private security organizations,
people located within a configurable radius of 0 to 2,000 meters from the user who pressed the button,
members of a particular network within a network system when a person is a member of it. It is also implied that after signing in a network system a person may join pre-determined groups or groups created by the users themselves. User groups may be classified according to various principles. For example: graduates of some university, co-workers, motorcyclists, residents of some neighborhood, national diasporas and so on.

User may individually pre-determine (selection may be done preliminarily in smartphone software) to whom the alarm signal and his/her location shall be sent when the alarm button is pressed in the smartphone program (soft button) and/or on the wearable electronic device (for example, a finger-ring) (hard button).

As to trusted organizations, their confirmation will be required to add them to the user list of trusted organizations.

An alarm signal along with the user's location may be sent to certain organizations using any communication system (GSM, CDMA, WI-FI, WIMAX, BLUETOOTH, etc.).

As to private security organizations, the alarm signal will be sent to the nearest rapid response team connected to our system. Call check will be obligatory for the rapid response team. Network system means software for mobile devices (APPLE iOS, GOOGLE ANDROID, MICROSOFT WINDOWS MOBILE operating systems, etc.), a web version and server side for further writing to it.

When an electronic alarm button in mobile software or a physical alarm button located on the electronic device connected to this system is pressed, alarm signal and location of the signal sender is sent to certain organizations.

As to the physical alarm button located on the wearable electronic device (for example, a finger-ring), to send an alarm signal a user needs to hold down the button for N seconds (in this case the wearable electronic device will vibrate indicating that a user is going to send an alarm signal). As to the electronic alarm button, a user shall also hold it down for N seconds.

The following script is performed after this:

In case of false pressing a user has N seconds to cancel the alarm signal through an application by entering his/her personal secret password. If no cancellation was initiated, the alarm signal with the user's location is sent to pre-determined organizations (one, several or all organizations may be selected):
To trusted organizations through a text message and to a mobile application.
To the police.
To private security organizations.
To people located within the configurable radius of 0 to 2,000 meters from the user who pressed the button.
To members of a personal network within a network system the person is the member of.

One embodiment stipulates that, after sending a signal to the police, a user receives a call to his/her phone for situation clarification. If there is no response to the call, a police unit can be sent to the user's location. The second embodiment stipulates that the police receives a digital signal with the user's location and sends a unit to him/her.

Upon receipt of an alarm signal respective recipients of the signal may track the user's movement on a map until the alarm signal is over (the alarm signal recipients will be able to see the alarm call card containing detailed information on the call: location at the moment of the call initiation, displacement route (if available) of the user who initiated the call, his/her current location, other responding organizations' response status, chat for coordination of the responding organizations' actions, etc.).

The user may cancel or end the call at any time by entering his/her secret password.

In case the user is forced to enter his/her password he/she may enter a second password upon entering of which the application will stop indicating alarm, but the police, rapid response team and trusted organizations will still go to the rescue.

The algorithm of functioning of the personal threat warning device is given below.

The devices works in two modes: the standby and the alarm mode (FIG. 7).

The first mode is the Standby Mode:

The device stays in a shutdown condition all the basic time.
1). At an interval of N seconds DD6 timer chip 15 provides power for the remaining part of battery 1 chip through DD5 voltage stabilizer 16 using VT1 switching transistor.
2). When power is supplied, the main BT controller starts (microprocessor BLUETOOTH module 13) (DD2 17).
3). DD2 controller 17 informs the user about the start by short-time starting M1 drive of vibrating motor 2 through VT2 switching transistor and light indication by means of LED1 and LED2 (9).
4). First of all, by means of VT3 transistor circuit, DD2 BT controller 17 checks if SW1 physical button 8 was pressed, i.e. the controller checks the condition upon which start was initiated:
   on button pressing, which means it is necessary to work in the Alarm Mode
   on a simple timer, which means it is necessary to work in the Standby Mode.
5). In the Standby Mode DD2 BT controller 17 reads settings from DD3 memory chip (memory unit 14) after the button status check and applies them.
6). After this operation DD2 BT controller 17 reads the battery status data from DD4 chip (the chip of charge control board 3).
7). If necessary, DD2 BT controller 17 switches on and sets a radio frequency route (BLUETOOTH) for communication with the user device and for transmission of settings and telemetry information. Information transmission is performed through DD1 matching device 18 and ANTI antenna 7.
8). Upon completion of the operations DD2 BT controller 17 sends a command for switching off of the device to DD6 timer chip 15. Having received this command DD6 chip 15 switches off power supply of the entire chip through VT1 switching transistor.

The operations described above are repeated at set interval of N. This interval may be changed within the range of 100 milliseconds to 2 hours.

The second mode is the Alarm Mode:

Switching on of the device is performed when alarm button 8 is pressed by user.
1). When SW1 button 8 connected to DD6 timer chip 17 is pressed DD6 chip 15 provides power for the remaining part of battery 1 chip through DD5 voltage stabilizer 16 using VT1 switching transistor.
2). When power is supplied, main DD2 BT controller 17 starts.
3). DD2 BT controller 17 informs the user about the start by short-time starting M1 drive through VT2 switching transistor and light indication by means of LEDs 9.
4). First of all, by means of VT3 transistor circuit, DD2 BT controller 17 checks if SW1 physical button 9 was pressed. Since SW1 button 9 was pressed the device switches to the Alarm Mode.
5). The device waits for K seconds (adjustable) and checks if SW1 button 8 was pressed again.
6). If the condition is met, DD2 BT controller 17 switches on and sets a radio frequency route (BLUETOOTH) for communication with the user device. It also switches on indication. And it writes to DD3 memory chip (memory unit 14).
7). When the radio frequency route is set transmission of an alarm message to the user device is performed, and the latter sends it to server. Message transmission is performed through DD1 matching device 18 and ANTI antenna 7.
8). On command from the user device the ring may switch back to the standby mode canceling the alarm mode. Upon receipt of the command DD2 BT controller 17 sends a signal for switching off of the device to DD6 timer chip 15. DD6 chip 15 switches off power supply of the entire chip through VT1 switching transistor.

### INDUSTRIAL APPLICABILITY

This invention is industrially applicable and may be manufactured using known technologies applied for manufacture of radio-transmitting communication means.

It should also be appreciated that various modifications, adaptations, and alternative embodiments thereof may be made within the scope and spirit of the present invention. The invention is further defined by the following claims.

What is claimed is:

1. A personal threat warning device comprising:
a body made in a form of a ring or a finger-ring adapted to be worn on a user's finger;
an internal power supply inside the body;
a processor connected to the power supply;
a wireless transmission unit for transmitting a signal representing a user personal threat warning to an external receiver;
a physical button installed outside the body for initiating the signal;
wherein the physical button is installed outside the body on an external face of the body, in a segment of a second and third quadrants in a clockwise direction on the body;
wherein the power supply is located at a top of the body, and wherein the processor, the wireless transmission unit and an antenna are located above the power supply,
wherein a vibrating motor that vibrates when the physical button is held down is located on one side of the body relative to the power supply, and
the physical button is located on another side of the body relative to the power supply, and
wherein the processor initiates signal transmission using the wireless transmission unit after deactivating the vibration motor.

2. The device according to claim 1, further comprising a positioning unit connected to the processor for transmitting user location data as part of the signal.

3. The device according to claim 1, further comprising a receiver configured to receive a cancellation signal from an external computing device.

4. The device according to claim 1, further comprising at least one LED on the external surface of a shank of the ring or the finger-ring.

5. The device according to claim 5, further comprising a communication unit for interfacing to a geolocation system to form a location signal and transmit it to the wireless transmission unit.

6. The device according to claim 1, wherein the processor and the wireless transmission unit are located on a circuit board, and are implemented as a BLUETOOTH controller.

7. A method of personal threat notification, comprising:
utilizing an application software installed on a mobile device to program a processor of a finger-ring worn on a user's finger,
wherein the finger-ring includes a wireless transmission unit connected to the processor and the processor is responsive to a pressing of a physical button on the finger-ring;
pressing the physical button to initiate the processor to form a signal representing a personal threat warning, and
transmitting the signal through the wireless transmission unit to the mobile device available remotely,
using the mobile device, retransmitting the signal from the finger-ring to a service responsible for the user security,
wherein the physical button on the ring or finger-ring is pressed and held down for N seconds before the processor forms the signal for transmitting through the wireless transmission unit, and
wherein, when the physical button is pressed in error for a time exceeding the N seconds, the notification of the personal threat warning is canceled by entering a password in the application software on the mobile device.
